(19) United States
(12) Patent Application Publication
(10) Pub. No.: US 2010/0191572 A1
(43) Pub. Date: Jul. 29, 2010

(54) Systems and Methods to Use Rules and Constraints for Service Consolidation

(75) Inventors: Patrick NEWMAN, Palo Alto, CA (US); Andrew KAO, Sunnyvale, CA (US); Aaron MUNTER, San Francisco, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: REARDEN COMMERCE, INC., Foster City, CA (US)

(21) Appl. No.: 12/360,040

(22) Filed: Jan. 26, 2009

(51) Int. Cl. G06Q 30/00; G06Q 50/00; G06Q 10/00

(52) U.S. Cl. 705/10; 705/26; 705/15

(57) ABSTRACT

Systems and methods to consolidate user preferences for a service and make suggestions for options related to the service. In one aspect, a computer-implemented method includes: storing preferences of a plurality of users for a service; storing past options that have been previously selected for the service; in response to a request for the service for a subset of the users, combining the preferences of the subset of the users to generate a preference set for the subset of the users, based on a set of predetermined rules, using a computer; and selecting an option based on the preference set generated for the subset of users and the past options that have been previously selected for the service, using the computer.

### FIELD OF THE TECHNOLOGY

At least some embodiments of the disclosure relate to data processing systems for the selection of options for a service.

### BACKGROUND

When people work long hours, they often prefer to order food to eat in the office, for lunch or dinner or both. The ordering is usually relegated to an assistant or a secretary, often of the manager of a group when the group is meeting and wants to meet during a meal. Thus, often is it the preferences and tastes of the person who does the ordering that determines what the group is served.

### BRIEF DESCRIPTION OF THE DRAWINGS

The embodiments are illustrated by way of example and not limitation in the figures of the accompanying drawings in which like references indicate similar elements.

FIG. 1 illustrates a system for service consolidation according to one embodiment.

FIG. 2 illustrates user groups for service consolidation according to one embodiment.

FIG. 3 illustrates a record for a user for service consolidation according to one embodiment.

FIG. 4 illustrates a method to selection an option for a service according to one embodiment.

FIG. 5 shows a data processing system which can be used on various embodiments.

### SUMMARY OF THE DESCRIPTION

Systems and methods to consolidate user preferences for a service and to make suggestions for options related to the service are described herein. Some embodiments are summarized in this section.

In one embodiment, a computer-implemented method includes: storing preferences of a plurality of users for a service; storing past options that have been previously selected for the service; in response to a request for the service for a subset of the users, combining the preferences of the subset of the users to generate a preference set for the subset of the users, based on a set of predetermined rules, using a computer; and selecting an option based on the preference set generated for the subset of users and the past options that have been previously selected for the service, using the computer.

In one embodiment, the option is presented to the subset of the users (e.g., via email, short message service (SMS), instant messages, web pages, etc.) and the users may vote to approve or reject the option suggested by the system.

For example, after receiving votes from the subset of the users, the system determines whether the option is approved based on the votes from the subset of the users. In response to the option being rejected by the votes from the subset of the users, the system determines an alternative option based on the preference set generated for the subset of users and the past options that have been previously selected for the service, using the computer. In response to the option being approved by the votes from the subset of the users, the system places an order of the service. For example, the system may automatically transmit the order request to the corresponding service provide via a web request, an email message, a text message, or via an electronic ordering system. In one embodiment, the service includes a meal service.

In one embodiment, the selecting of the option is based on historic fairness in view of the past options that have been previously selected for the subset of the users.

In one embodiment, the preference set is randomized to select the option. The option may be selected based further on ratings of providers of the service (e.g., rated by the users or by a general population). In one embodiment, the selecting of the option includes excluding at least one option when the at least one option has been used with a predetermined period of time.

In one embodiment, the option is selected based further on a budgetary constraint rule; and the budgetary constraint rule is based on identities of the subset of the users.

In one embodiment, the set of predetermined rules may include at least one of: medical restrictions, religious restrictions, and cultural restrictions.

In one embodiment, the system may receive preferences of at least one guest; and the option is selected based further upon the preferences of the at least one guest.

In one embodiment, users may selectively join the subset; and the system is designed to receive at least one request from at least one of the users to join the subset, wherein the subset is identified based on at least one request.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

One embodiment of the disclosure provides a system and method to include and consider the preferences of the members of the group for whom the person is ordering a service, such as a meal service. The system and method performs randomization to provide variations in the orders of the service. For example, the system and method provides randomization and variations of food orders, so that, while the general preferences of group members are considered, the system does not always order the same thing for the same person.

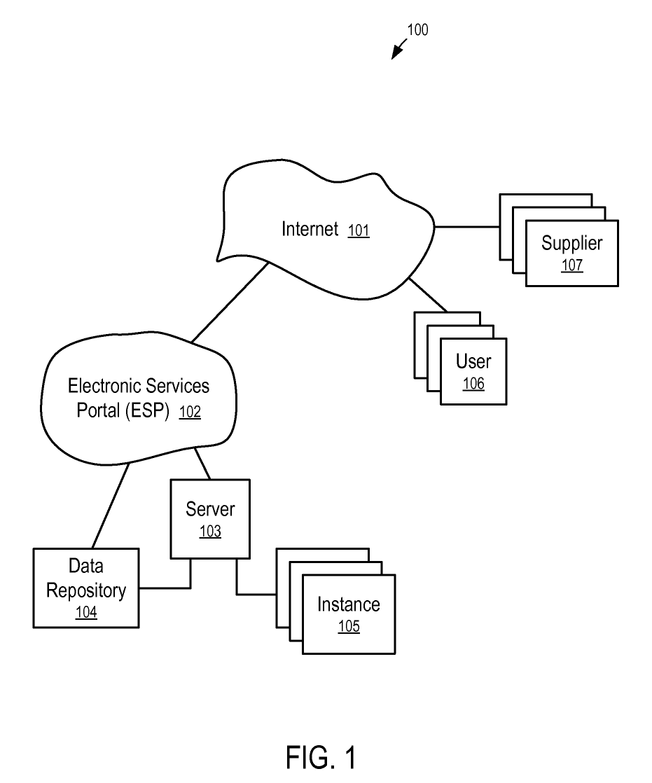

FIG. 1 shows an exemplary overview of a system 100 according to one embodiment of the disclosure. In FIG. 1, an electronic services portal (ESP) 102 connects to a server 103 and a data repository 104. The server 103 hosts software instances (e.g., 105), which, depending on the implementation of the system 100, may be one, several, or many instances. These software instances are to be considered only exemplary indications of how the software could be installed in server 103 and how it could work in conjunction with ESP 102, personal information managers (PIMs, not shown), and main data repository 104. The EPS 102 connects via Internet 101 to system users 106 (e.g., 106) and suppliers (e.g., 107). These connections could also be through direct connection, through a phone system, or through any other suitable networking method, known or to be invented, such as a local area network, an intranet, a wireless telecommunication network, etc.

In one embodiment, the EPS 102 includes a web site to communicate with the users 106 using a web browser. The users 160 may register with the ESP 102, to selectively join a group or to vote on proposed service options, etc.

In one embodiment, applications running on the devices used by the users 106 (not shown in FIG. 1) communicate with the EPS 102 to synchronize preferences information and other information, such as schedule, meeting, etc., to identify members of a group in an automated way.

In one embodiment, the software instance 105 is for a specific group of users 106. Alternatively, the software instance 105 may service multiple groups of users 106, where each of the group may be a different business entity.

In one embodiment, the data repository 104 stores the preferences of the uses 106, including positive preferences and negative preferences. The data repository 104 may further store the history of services orders and voting records of the users. Voting records for previous service orders may indicate the positive and/or negative preferences of the users (106).

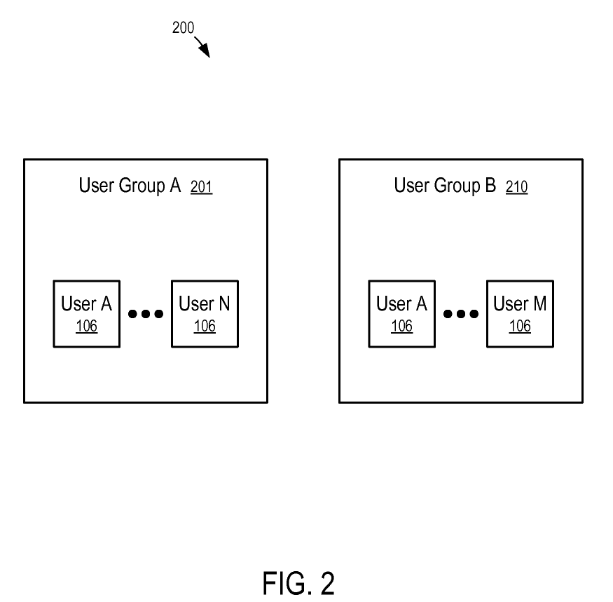

FIG. 2 shows a simplified overview of exemplary user groupings 200 according to one embodiment. In FIG. 2, two user groups 201 and 210 have, respectively, member users 106 (e.g., users A-N for group A, and users A-N for group B).

In one embodiment, for each user 106 the system has records of known preferences, based on data in one or more databases, such as data repository 104 or other suitable facilities. Such data may include, for example, the preferences, suggestions, and other personal information entered by each member in his user profile, as well as historic data drawn from previous selections made by the user.

In one embodiment, the user groups (e.g., 201, 210) are predefined. In one embodiment, a user group may be dynamically determined based on user's request to opt-in a group. For example, the users may opt-in to a group that needs a meal service for a particular time period. For example, a user on the system could make a request indicating that he or she is working late and would like dinner. The system aggregates the opt-in requests and makes an order of an appropriate quantity that would be palatable to the group of users that send in the opt-in requests.

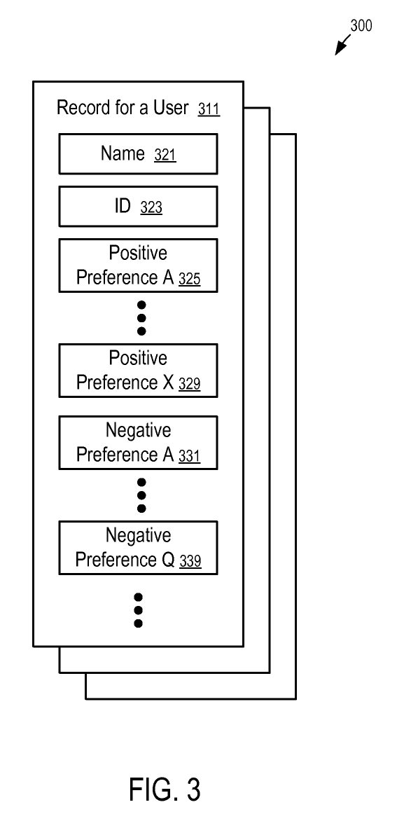

FIG. 3 shows a simplified overview of exemplary records 300 according to one embodiment of the disclosure. In one embodiment, each of records 311 contains user profile data for a user 106, including the name 321, ID 323, positive preferences 325-329, and negative preferences 331-339. These positive and negative preferences are based on many criteria, including but not limited to expressed listings of food preferences, restaurant ratings, both positive and negative, types of restaurants patronized repeatedly and types of restaurants not patronized, indicated food allergies, recorded opinions, etc.

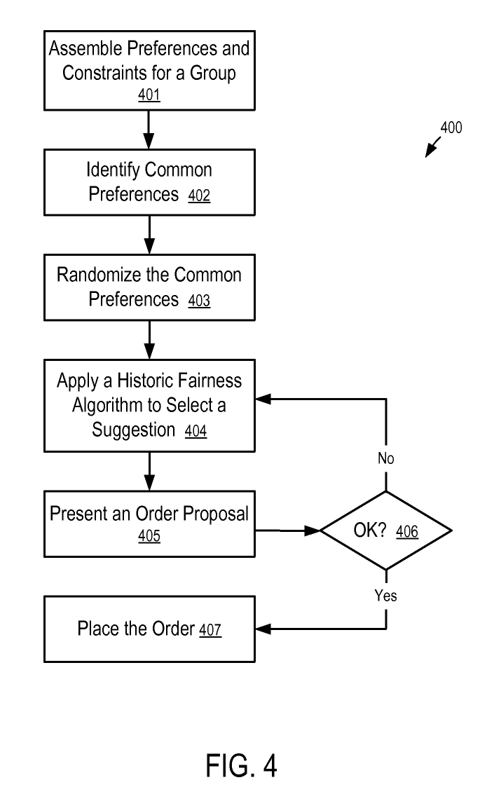

FIG. 4 shows an exemplary process 400 for implementation of the system according to one embodiment of the disclosure. In FIG. 4, the system assembles 401 the known preferences, positive and negative, of members of a group (e.g., group 210).

For example, the positive preferences for food types may be ranked in order as Italian, pizza, Chinese, burgers, and Indian food; while negative preferences, in order, start with seafood and Italian food. These negative preferences may be based on individual taste, food allergies, religious or cultural restrictions, etc.

In FIG. 4, the system then identifies 402 common preferences for the group by compiling a list of possible positive preferences common among all group members, which, in one example, may be pizza, Chinese, burgers, and Indian food.

In one embodiment, the order of preferred foods in this list is not important, because the system randomizes 403 the order of preferences.

In FIG. 4, the system applies 404 a historic fairness algorithm to select a suggestion, drawing data from database 104, based on the last several instances, for example, the last five instances of food ordered by the group. Thus food that has been ordered very recently, for example, in the last two days, may be excluded from the list of suggestions or common preferences.

After the calculations, the system submits or presents 405 an order proposal for the group. If 406 the order proposal is not approved, the system loops back to apply 404 a historic fairness algorithm to generate another order proposal.

Approval of the order proposal may be obtained in various ways. For example, a group manager or his/her delegate could approve/disapprove the order. Alternatively, the system may submit the proposal to the group members via text messages, instant messaging, email, or other, similar means. Group members then vote within a specified time period, such as, for example, five minutes, and the system then acts on those votes. When the system obtains approval, by any of various means, of the order proposal, it places 407 the order, with scheduling and delivery arrangements as required.

The system and method of the present disclosure may be used by groups of many sizes, such as a project team, a department, or even at the company level.

In addition, one or more group members may add one or more guests, so that their food preferences and, in particular, their restrictions, such as for reasons of food allergies or religious or cultural restrictions, are also taken into account.

In some cases the guests may be allowed to vote on the order proposal, while in other cases, they would not be included in the voting process.

In determining the common preferences and/or the suggestions, the system may apply various constraints and rules, such as budgetary constraints, ratings of service providers by general population, etc.

For example, the constraint of budgetary allowance may be based on the situation or standing with the organization. A higher budget may be allowed, for example, a team working late as opposed to a team ordering lunch. More budget flexibility might be extended to a group of VP's, or a meal for that includes a guest from a partner or customer.

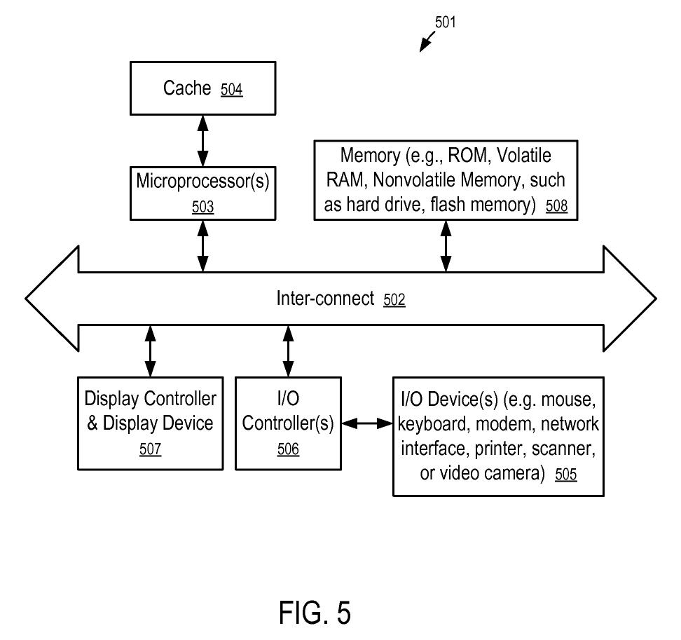

FIG. 5 illustrates a data processing system which can be used in various embodiments. While FIG. 5 illustrates various components of a computer system, it is not intended to represent any particular architecture or manner of interconnecting the components. Some embodiments may use other systems that have fewer or more components than those shown in FIG. 5.

In one embodiment, a server data processing system illustrated in FIG. 5 implements at least one of the components shown in FIG. 1, such as the electronic services portal (ESP) 102, the server 103, and/or the data repository 104. In one embodiment, a user terminal as a data processing system as illustrated in FIG. 5 is used by the users 106 to access the software instance 105.

In FIG. 5, the data processing system 501 includes an inter-connect 502 (e.g., bus and system core logic), which interconnects a microprocessor(s) 503 and memory 508. The microprocessor 503 is coupled to cache memory 504 in the example of FIG. 5.

The inter-connect 502 interconnects the microprocessor(s) 503 and the memory 508 together and also interconnects them to a display controller and display device 507 and to peripheral devices such as input/output (I/O) devices 505 through an input/output controller(s) 506. Typical I/O devices include mice, keyboards, modems, network interfaces, printers, scanners, video cameras and other devices which are well known in the art. In some embodiments, when the data processing system is a server system, some of the I/O devices, such as printer, scanner, mice, and/or keyboards, are optional.

The inter-connect 502 may include one or more buses connected to one another through various bridges, controllers and/or adapters. In one embodiment the I/O controller 506 includes a USB (Universal Serial Bus) adapter for controlling USB peripherals, and/or an IEEE-1394 bus adapter for controlling IEEE-1394 peripherals.

The memory 508 may include ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, various functions and operations may be described as being performed by or caused by software code to simplify description. However, those skilled in the art will recognize that what is meant by such expressions is that the functions result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The instructions may be embodied in digital and analog communication links for electrical, optical, acoustical or other forms of propagated signals, such as carrier waves, infrared signals, digital signals, etc.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method, comprising:
storing preferences of a plurality of users for a service;
storing past options that have been previously selected for the service;
in response to a request for the service for a subset of the users, combining the preferences of the subset of the users to generate a preference set for the subset of the users, based on a set of predetermined rules, using a computer; and
selecting an option based on the preference set generated for the subset of users and the past options that have been previously selected for the service, using the computer.

2. The method of claim 1, further comprising:
presenting the option to the subset of the users.

3. The method of claim 2, further comprising:
receiving votes from the subset of the users; and
determining whether the option is approved based on the votes from the subset of the users.

4. The method of claim 3, further comprising:
in response to the option being rejected by the votes from the subset of the users, determining an alternative option based on the preference set generated for the subset of users and the past options that have been previously selected for the service, using the computer.

5. The method of claim 3, further comprising:
in response to the option being approved by the votes from the subset of the users, placing an order of the service by the computer.

6. The method of claim 5, wherein the service comprises a meal service.

7. The method of claim 2, wherein the option is presented to the subset of users via email.

8. The method of claim 2, wherein the option is presented to the subset of users via short message service (SMS).

9. The method of claim 1, wherein the selecting of the option is based on historic fairness in view of the past options that have been previously selected for the subset of the users.

10. The method of claim 1, further comprising:
randomizing the preference set generated for the subset of the users to select the option.

11. The method of claim 1, wherein the preferences includes positive preferences and negative preferences.

12. The method of claim 1, wherein the option is selected based further on ratings of providers of the service.

13. The method of claim 1, wherein the selecting of the option includes excluding at least one option when the at least one option has been used with a predetermined period of time.

14. The method of claim 1, wherein the option is selected based further on a budgetary constraint rule.

15. The method of claim 14, wherein the budgetary constraint rule is based on identities of the subset of the users.

16. The method of claim 1, wherein the set of predetermined rules include at least one of:
medical restrictions, religious restrictions, and cultural restrictions.

17. The method of claim 1, further comprising:
receiving preferences of at least one guest;
wherein the option is selected based further upon the preferences of the at least one guest.

18. The method of claim 1, further comprising:
receiving at least one request from at least one of the users to join the subset, wherein the subset is identified based on at least one request.

19. A computer-readable media storing instructions, the instructions causing a computer to perform a method, the method comprising:
storing preferences of a plurality of users for a service;
storing past options that have been previously selected for the service;
in response to a request for the service for a subset of the users, combining the preferences of the subset of the users to generate a preference set for the subset of the users, based on a set of predetermined rules; and
selecting an option based on the preference set generated for the subset of users and the past options that have been previously selected for the service.

20. A computer system, comprising:
a means for storing preferences of a plurality of users for a service;
a means for storing past options that have been previously selected for the service;
a means for combining the preferences of a subset of the users to generate a preference set for the subset of the users, based on a set of predetermined rules, in response to a request for the service for the subset of the users; and
a means for selecting an option based on the preference set generated for the subset of users and the past options that have been previously selected for the service.
